(19) United States
(12) Patent Application Publication
(10) Pub. No.: US 2023/0394746 A1
(43) Pub. Date: Dec. 7, 2023

(54) Multi-Room 3D Floor Plan Generation

(71) Applicant: Apple Inc., Cupertino, CA (US)

(72) Inventors: Kai Kang, Sunnyvale, CA (US); Shian-Ru Ke, Palo Alto, CA (US); Feng Tang, Cupertino, CA (US); Hongyu Xu, San Jose, CA (US); Maximilian W. Maung, San Jose, CA (US)

(21) Appl. No.: 18/202,043

(22) Filed: May 25, 2023

Related U.S. Application Data
(60) Provisional application No. 63/348,720, filed on Jun. 3, 2022.

(51) Int. Cl. G06T 15/20; G06T 19/20

(52) U.S. Cl. CPC G06T 15/205; G06T 19/20; G06T 2219/2004

(57) ABSTRACT

Various implementations provide a 3D floor plan based on scanning multiple rooms. A combined, multi-room 3D floor plan may be generated from multiple 3D floor plans from distinct, non-contiguous room scans, e.g., a first scan that is distinct from a second scan. In some implementations, combining 3D floor plans utilizes a process that, during a second scan, re-localizes in the first room and then tracks the device as the device moves (e.g., as the user walks) to the second room to scan the second room. In other implementations, combining 3D floor plans is based on user input, e.g., positioning the multiple 3D floor plans relative to one another based at least in part on a user positioning graphical representations of the floor plans relative to one another on a user interface.

### CROSS-REFERENCE TO RELATED APPLICATIONS

This application claims the benefit of U.S. Provisional Application Ser. No. 63/348,720 filed Jun. 3, 2022, which is incorporated herein in its entirety.

### TECHNICAL FIELD

The present disclosure generally relates to electronic devices that use sensors to scan physical environments to generate three dimensional (3D) models such as 3D floor plans.

### BACKGROUND

Existing scanning systems and techniques may be improved with respect to assessing and using the sensor data obtained during scanning processes to generate 3D representations such as 3D floor plans representing physical environments.

### SUMMARY

Various implementations disclosed herein include devices, systems, and methods that provide multi-room 3D floor plans. For example, a multi-room 3D floor plan may be formed by combining 3D floor plans from multiple individual room scans. A 3D floor plan is a 3D representation of a room or other physical environment that generally identifies or otherwise represents 3D positions of one or more walls, floors, ceilings, or other boundaries or regions of the environment. Some implementations disclosed herein generate a 3D floor plan that identifies or otherwise represents 3D positions of windows, doors, and/or openings within the 3D floor plan, e.g., on the walls, floors, ceilings, or other regions. Some implementations generate a 3D floor plan that generally identifies or otherwise represents 3D positions of one or more walls, floors, ceilings, or other boundaries or regions of the environment as well as the 3D positions of tables, chairs, appliances, and other objects within the environment.

A combined, multi-room 3D floor plan may be generated from multiple 3D floor plans from distinct, non-contiguous room scans. In some implementations, combining 3D floor plans utilizes a process that captures sensor data of the first room during a first scan and then, during a second scan, re-localizes in the first room and tracks the device as the device moves (e.g., as the user walks) to the second room to scan the second room. In other implementations, combining 3D floor plans is based on user input, e.g., positioning the multiple 3D floor plans relative to one another based at least in part on a user positioning graphical representations of the floor plans relative to one another on a user interface.

In some implementations, a processor performs a method by executing instructions stored on a computer readable medium. The method generates a first three-dimensional (3D) floor plan of a first room of a multi-room environment based on a first 3D representation (e.g., a first 3D point cloud or 3D mesh) of one or more boundary features (e.g., walls, doors, windows, etc.) of the first room. The first 3D representation is generated based on a first scan. The method further generates a second 3D floor plan of a second room of the multi-room environment based on a second 3D representation (e.g., a second 3D point cloud or 3D mesh) of one or more boundary features (e.g., walls, doors, windows, etc.) of the second room. The second 3D representation is generated based on a second scan that is distinct from the first scan, i.e., tracking of scanning device position may not be continuous between the two scan and thus cannot be used to positionally associate the scans with one another. The method determines a 3D positional relationship between the first 3D floor plan and the second 3D floor plan. An automatic re-localization and/or manual alignment process may be used to determine the 3D positional relationship so that the 3D floor plans can be aligned in 3D space, i.e., the same 3D coordinate system. The 3D positional relationship between the 3D floor plans may be adjusted by an improvement or optimization post process. The method generates a combined 3D floor plan based on the determined 3D positional relationship between the first 3D floor plan and the second 3D floor plan.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-B illustrate a physical environment in accordance with some implementations.

FIG. 2 illustrates a portion of a 3D point cloud representing the first room of FIGS. 1A-B in accordance with some implementations.

FIG. 3 illustrates a portion of a first 3D floor plan representing the first room of FIGS. 1A-B, in accordance with some implementations.

FIG. 4 is a view of the 3D floor plan of FIG. 3.

FIG. 5 is another view of the 3D floor plan of FIGS. 3 and 4.

FIG. 6 is a view of a second 3D floor plan of a second room.

FIG. 7 is a view of a combined 3D floor plan that combines the first 3D floor plan of FIGS. 3-5 with the second 3D floor plan of FIG. 6 in accordance with some implementations.

FIGS. 8A-I illustrate an exemplary multi-room 3D floor plan process in accordance with some implementations.

FIGS. 9A-C illustrate use of a user interface to position 3D floor plans relative to one another in accordance with some implementations.

FIG. 10 is a flowchart illustrating a method for improving a combined 3D floor plan in accordance with some implementations.

FIG. 11 is a flowchart illustrating a method for generating a combined 3D floor plan in accordance with some implementations.

FIG. 12 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

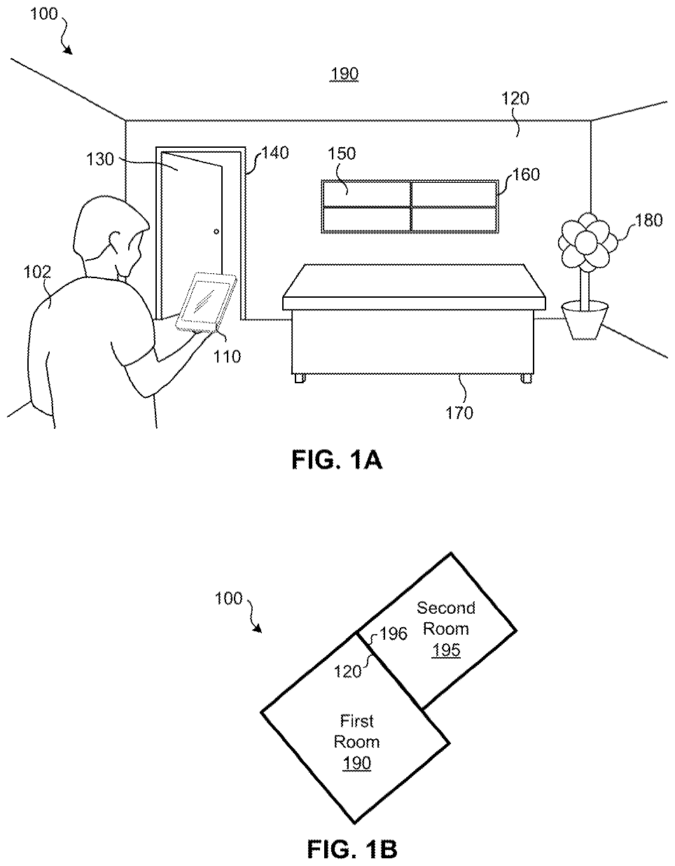

FIGS. 1A-B illustrate an exemplary physical environment 100. In this example, FIG. 1A illustrates an exemplary electronic device 110 operating in a first room 190 of the physical environment 100. In this example of FIG. 1A, the first room 190 includes a door 130 (providing an opening leading to a second room 195 of the physical environment 100), a door frame 140, and a window 150 (with window frame 160) on wall 120. The first room 190 also includes a desk 170 and a potted plant 180. As illustrated in the top-down view of FIG. 1B, the first room 190 and second room 195 abut one another, i.e., a portion of the wall 120 of the first room 190 abuts (e.g., is the opposite side of) the wall 196 of the second room 195.

The electronic device 110 includes one or more cameras, microphones, depth sensors, motion sensors, or other sensors that can be used to capture information about and evaluate the physical environment 100. The obtained sensor data may be used to generate a 3D representation, such as a 3D point cloud, a 3D mesh, or a 3D floor plan.

In one example, the user 102 moves around the physical environment 100 and device 110 captures sensor data from which one or more 3D floor plans of the physical environment 100 are generated. The device 110 may be moved to capture sensor data from different viewpoints, e.g., at various distances, viewing angles, heights, etc. The device 110 may provide information to the user 102 that facilitates the environment scanning process. For example, the device 110 may provide a view from a camera showing the content of RGB images currently being captured, e.g., a live camera feed, during the room scanning process. As another example, the device 110 may provide a view of a live 3D point cloud or a live 3D floor plan to facilitate the scanning process or otherwise provides feedback that informs the user 102 of which portions of the physical environment 100 have already been captured in sensor data and which portions of the physical environment 100 require more sensor data in order to be represented accurately in a 3D representation and/or 3D floor plan.

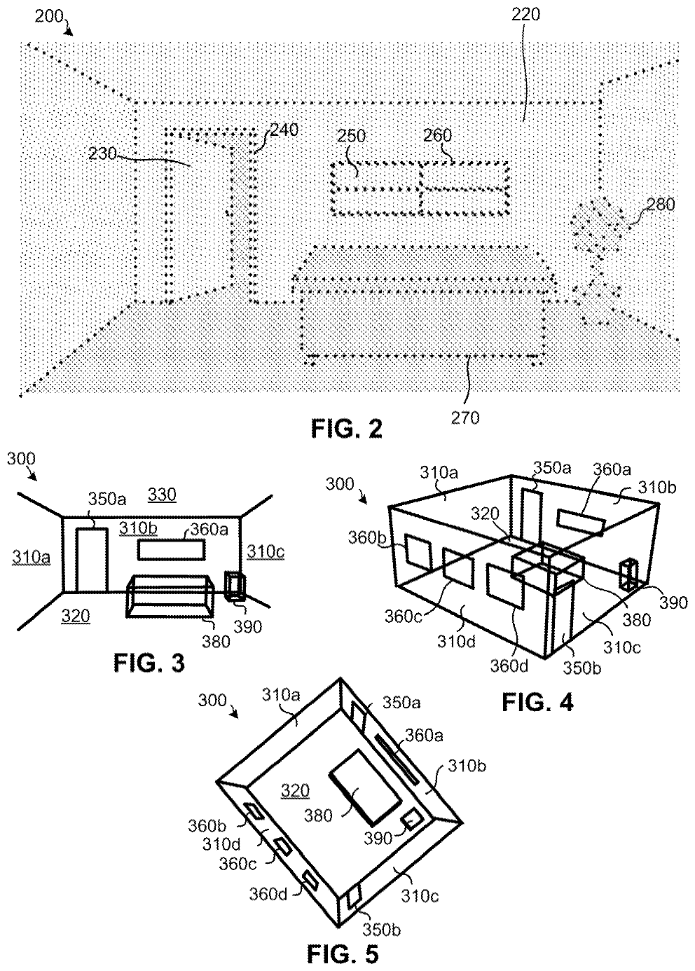

The device 110 performs a scan of the first room 190 to capture data from which a first 3D floor plan 300 (FIG. 3-5) of the first room 190 is generated. In this process, for example, a dense point-based representation, such as a 3D point cloud 200 (FIG. 2), may be generated to represent the first room 190 and used to generate the first 3D floor plan 300, which may represent the 3D positions of the walls, wall openings, windows, doors, and objects of the first room 190. In some implementations, a 3D floor plan defines the positions of such elements using non-point cloud data such as one or more parametric representations. For example, such a parametric representation may define 2D/3D shapes (e.g., primitives) that represent the positions and sizes of elements of a room in the 3D floor plan. In some implementations, a 3D floor plan of a room, such as the first room 190, is generated based on a 3D point cloud that is generated during a first scan of the first room 190, e.g., a scan captured as user 102 walks around the first room 190 capturing sensor data.

FIG. 2 illustrates a portion of a 3D point cloud representing the first room 190 of FIGS. 1A-B. In some implementations, the 3D point cloud 200 is generated based on one or more images (e.g., greyscale, RGB, etc.), one or more depth images, and motion data regarding movement of the device in between different image captures. In some implementations, an initial 3D point cloud is generated based on sensor data and then the initial 3D point cloud is densified via an algorithm, machine learning model, or other process that adds additional points to the 3D point cloud. The 3D point cloud 200 may include information identifying 3D coordinates of points in a 3D coordinate system. Each of the points may be associated with characteristic information, e.g., identifying a color of the point based on the color of the corresponding portion of an object or surface in the physical environment 100, a surface normal direction based on the surface normal direction of the corresponding portion of the object or surface in the physical environment 100, a semantic label identifying the type of object with which the point is associated, etc.

In alternative implementations, a 3D mesh is generated in which points of the 3D mesh have 3D coordinates such that groups of the mesh points identify surface portions, e.g., triangles, corresponding to surfaces of the first room 190 of the physical environment 100. Such points and/or associated shapes (e.g., triangles) may be associated with color, surface normal directions, and/or semantic labels.

In the example of FIG. 2, the 3D point cloud 200 includes a set of points 220 representing wall 120, a set of points 230 representing door 130, a set of points 240 representing the door frame 240, a set of points 250 representing the window 150, a set of points 260 representing the window frame 160, a set of points 270 representing the desk 170, and a set of points 280 representing the potted plant 180. In this example, the points of the 3D point cloud 200 are depicted with relative uniformity and with points on object edges emphasized to facilitate easier understanding of the figures. However, it should be understood that the 3D point cloud 200 need not include uniformly distributed points and need not include points representing object edges that are emphasized or otherwise different than other points of the 3D point cloud 200.

The 3D point cloud 200 may be used to identify one or more boundaries and/or regions (e.g., walls, floors, ceilings, etc.) within the first room 190 of the physical environment 100. The relative positions of these surfaces may be determined relative to the physical environment 100 and/or the 3D point-based representation 200. In some implementations, a plane detection algorithm, machine learning model, or other technique is performed using sensor data and/or a 3D point-based representation (such as 3D point cloud 200). The plane detection algorithm may detect the 3D positions in a 3D coordinate system of one or more planes of physical environment 100. The detected planes may be defined by one or more boundaries, corners, or other 3D spatial parameters. The detected planes may be associated with one or more types of features, e.g., wall, ceiling, floor, table-top, counter-top, cabinet front, etc., and/or may be semantically labelled. Detected planes associated with certain features (e.g., walls, floors, ceilings, etc.) may be analyzed with respect to whether such planes include windows, doors, and openings. Similarly, the 3D point cloud 200 may be used to identify one or more boundaries or bounding boxes around one or more objects, e.g., bounding boxes corresponding to table 170 and plant 180.

The 3D point cloud 200 is used to generate first floor plan 300 (as illustrated in FIGS. 3-5) representing the first room 190 of the physical environment 100 of FIGS. 1A-B. For example, detected planes, boundaries, bounding boxes, etc. may be detected and used to generate shapes (e.g., 2D/3D primitives that represent the elements of the first room 190 of the physical environment 100. In FIGS. 3-5, wall representations 310a-d represent the walls of the first room 190 (e.g., wall representation 310b represents wall 120), floor representation 320 represents the floor 320 of the first room 190, door representations 350a-b represent the doors of the first room 190 (e.g., door representation 350a represents door 130), window representations 360a-d represent the windows of the first room 190 (e.g., window representation 360a represents window 150), desk representation 380 is a bounding box representing desk 170 and flowers representation 290 is a bounding box representing flowers 180. In this example, since the 3D floor plan includes object representations for non-room-boundaries, e.g., for 3D objects within the room such as desk 170 and flowers 180, the 3D floor plan may be considered a 3D room scan. In other implementations, a 3D floor plan represents only room boundary features, e.g., walls, floor, doors, windows, etc.

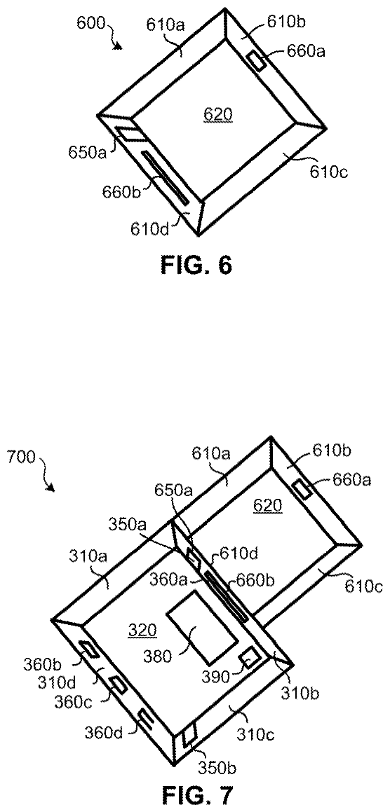

A similar (but distinct) scanning process is used to generate a second floor plan 600 (as illustrated in FIG. 6) of a second room 195 of the physical environment 100 of FIGS. 1A-B. Such a second scan may be based on sensor data obtained within the second room 195. For example, detected planes, boundaries, bounding boxes, etc. may be detected and used to generate shapes, e.g., 2D/3D primitives that represent the elements of the second room 195 of the physical environment 100. In FIG. 6, wall representations 610a-d represent the walls of the second room 195, floor representation 620 represents the floor of the second room 195, door representation 650a represents the door of the second room 195, and window representations 660a-b represent the windows of the second room 195.

As described, the first 3D floor plan 300 of FIGS. 3-5 and the second 3D floor plan 600 of FIG. 6 are generated by a first and second room scan, respectively. Such room scans may be distinct or non-contiguous such that device motion tracking between scans is unavailable, inaccurate, or otherwise not available for use in accurately positionally associating the distinct 3D floor plans. Implementations disclosed herein address such lack of positional association by determining positional associations between multiple, distinct 3D floor plans using various techniques.

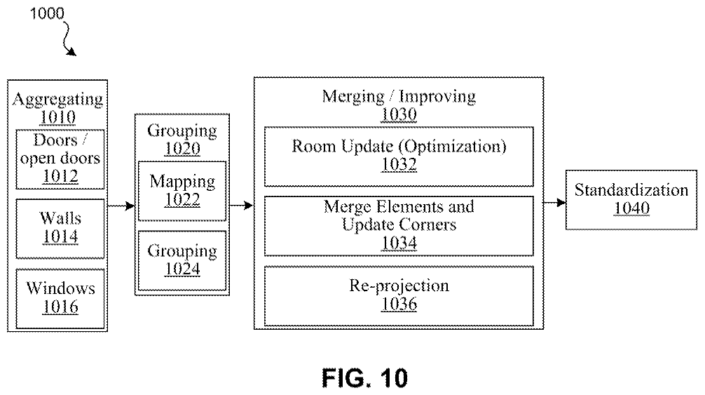

Given a determined positional relationship between multiple, distinct 3D floor plans, the 3D floor plans can be combined (e.g., stitched together into a single representation) to form a single, combined 3D floor plan. FIG. 7 is a view of a combined 3D floor plan 700 that combines the first 3D floor plan 300 of FIGS. 3-5 with the second 3D floor plan of FIG. 6. As illustrated, the 3D floor plans 300, 600 are positioned adjacent to one another and aligned with one another in ways that accurately correspond to the positional relationship between the first and second rooms 190, 195 that the 3D floor plans 300, 600 represent. For example, the floors of the first room 190 and second room 195 may be level with one another in the physical environment 100 and thus the floor representations 320, 620 may be level (on the same plane) with one another in the combined 3D floor plan 700. As another example, wall representation 310b (corresponding to wall 120) and wall representation 610d (corresponding to wall 196) may abut one another based on the walls 120, 196 being two sides of the same wall in physical environment 100. In some implementations such abutting walls are merged into a single wall (e.g., as described with respect to FIG. 10). Similarly, walls, doors and door openings, windows and window openings, other openings, and other features may be accurately aligned or otherwise positioned based on an accurate positional relationship between the distinct 3D floor plans 300, 600. In the case of merged walls, doors, windows, etc. from the merged walls may be projected onto the merged walls to provide an accurate and aligned appearance.

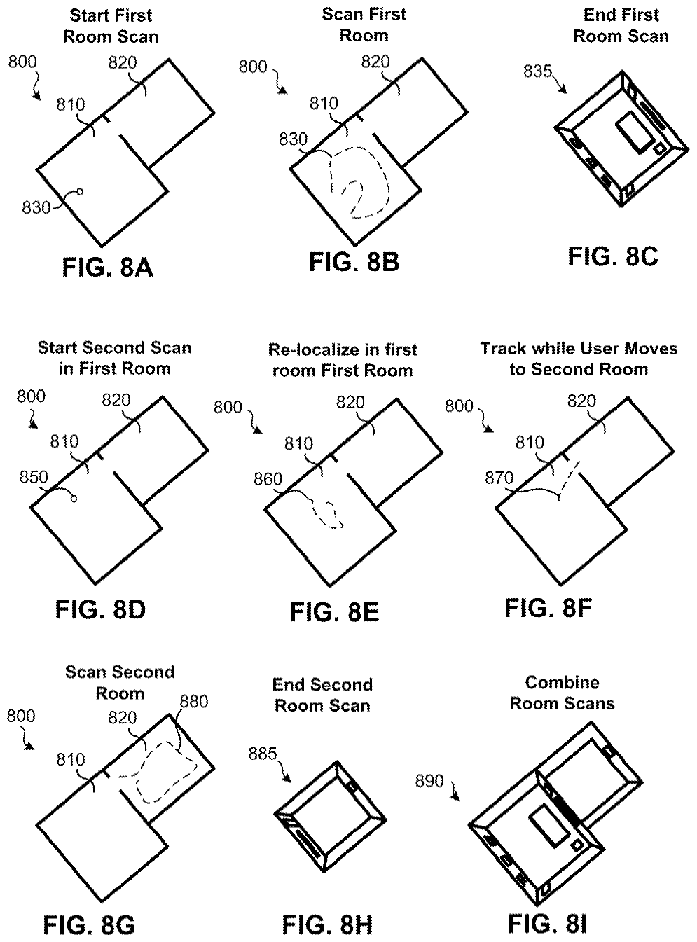

FIGS. 8A-I illustrate an exemplary multi-room 3D floor plan process. In this example, as illustrated in FIG. 8A, a user initiates a first scan from a starting position 830 within a first room 810 of a physical environment 800. As illustrated in FIG. 8B, during the first scan, the user walks along path 830 capturing images of various portions of the first room 810. As illustrated in FIG. 8B, at some point after the end of this first scan, a first 3D floor plan 835 is generated. At this point, the user need not continue scanning and the device need not track its position. The user may (or may not) take a break or otherwise wait (e.g., waiting a minute, hour, day, hour, week, month, etc.) before performing a second scan.

As illustrated in FIG. 8D, the user initiates the second scan in the first room 810 of the physical environment 800 from position 850. As illustrated in FIG. 8E, during this initial portion of the second scan, the device re-localizes within the first room 810, for example, by capturing sensor data as the user moves about (e.g., along path 860) within the first room. The re-localization may involve matching features in sensor data captured during the first scan with sensor data captured during the second scan's initial portion, both of which are based on data captures within the first room 810. Feature points detected in 2D images of the second scan, for example, can be mapped with respect to 3D locations of those features points that were determined based on localization performed based on the sensor data from the first scan. In some implementations, a simultaneous localization and mapping (SLAM) technique is used to re-localize during the second scan based on data from the first scan.

In some implementations, a user interface guides the user to start the second scan in a previously-scanned room (e.g., in the first room 810), guides the user to obtain re-localization data (e.g., by walking around or moving the device to capture sensor data of the previously-scanned room), and/or notifies the user once localization is complete, e.g., with guidance to move to a second room to generate a second 3D floor plan of the second room.

As illustrated in FIG. 8F, the device tracks the user moving (e.g., walking) from the first room 810 to the second room 820 of the physical environment 800 along path 870. Tracking the device motion may be based on motion sensor (e.g., accelerometer, gyroscope, etc.) data and/or visual inertial odometry (VIO) and/or other image-based motion tracking. Tracking via motion sensor, VIO, etc. may be continuous as the user moves the device from the first room 810 to the second room 820. The tracking may involve determining whether a user is changing floor/stories within a building, e.g., by detecting a staircase, that the user is traversing the staircase, whether the user is going up or down the staircase, the height of the staircase, etc. based on sensor data. For example, images and/or depth data may be captured and used to determine that the device is moving from a ground floor to a basement or vice versa.

The re-localization and subsequent tracking of movement from the first room 810 to the second room 820 provides data than enables determining a positional relationship between the 3D floor plans generated from the first and second scans.

As illustrated in FIG. 8G, the second room 820 is scanned after the user has re-localized (FIG. 8E) and moved to the second room 820 (FIG. 8F). In some implementations, the device automatically detects that the device is capturing data for a new room (i.e., different than the first room 810) and automatically starts capturing scan data for use in generating the 3D floor plan of the second room 820. This may occur during the movement along path 870 (e.g., while the user is still in the first room 810 or after the user has entered the second room 820). In some implementations, the user provides input to start the capturing of the scan data for use in generating the 3D floor plan of the second room 820. During the scan of the second room 820 the user may capture sensor data of the second room 820, for example, as the user moves along path 880. As illustrated in FIG. 8H, at some point after the end of this second scan, a second 3D floor plan 885 is generated. The re-localization and subsequent tracking of movement from the first room 810 to the second room 820 provides localization data than enables a determining a positional relationship between the 3D floor plans generated from the first and second scans. This positional relationship is used, as illustrated in FIG. 8I, to generate a combined 3D floor plan 890 in which the first 3D floor plan 835 and second 3D floor plan 885 are combined in a positionally accurate way. An optimization process may be used to combine the rooms in a way that reduces or minimizes artifacts and/or errors, e.g., alignment imperfections between aligned walls, corners, door, windows, doors, hallway walls not appearing parallel, door/door opening/windows not lining up precisely, etc.

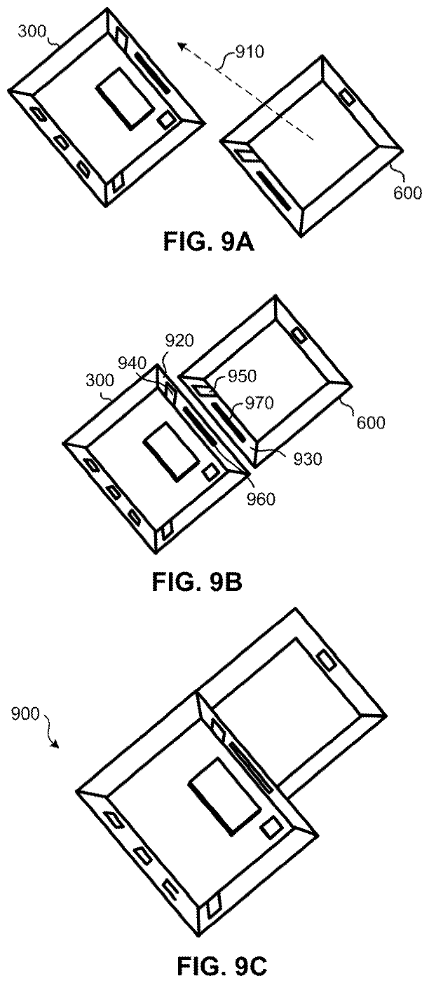

FIGS. 9A-C illustrate a user interface used to position 3D floor plans relative to one another to generate a combined 3D floor plan. In this example, a user interface is presented to a user showing each of two different 3D floor plans 300, 600. In this case, the user interface provides a top-down perspective view of the 3D floor plans 300, 600. These 3D floor plans 300, 600 may be partially aligned in the view based on automatic processes in the view. For example, floor planes may be automatically aligned and/or the 3D floor plans 300, 600 may aligned automatically oriented based on aligning a cardinal direction (e.g., North) associated with each of the 3D floor plans 300, 600, which may be known from the scanning data used to generate each of the 3D floor plans 300, 600.

As illustrated in FIG. 9A, the user provides input moving (e.g., translating, rotating, etc.) a representation of the second 3D floor plan 600 along path 910 to a position and orientation approximately adjacent to the representation of the first 3D floor plan 300. In another example, the user makes multiple selections to indicate a repositioning, e.g., identifying a starting location and an ending location or identifying two portions (e.g., individual walls) of each of the floor plans 300, 600 that should be aligned with one another (e.g., as opposite sides of the same wall).

As illustrated in FIGS. 9B and 9C, processing logic interprets the user input moving the representation of the second 3D floor plan 600 along path 910 and/or the new relative positioning of the representations of the first 3D floor plan 300 and the second 3D floor plan 600 to determine that wall 920 should be positioned adjacent to wall 930. The processing logic further determines how to align these walls based on matching features of the 3D floor plans 300, 600. For example, this may involve matching the position of door 940 with door 950 and/or matching the position of window 960 with window 970. If the processing logic determines that no alignment of the walls will match the features of the 3D floor plans 300, 600, it may present a warning or other indication to the user of the potential discrepancy.

In some implementations, processing logic examines walls, windows, doors, and other features of adjacent rooms and proposes one or more potential adjacent room combinations to the user and the user selects from the one or more proposals or provides input specifying a custom combination.

In some implementations, the user manually repositions one or more of the 3D floor plans 300, 600 on a user interface and need only roughly position the 3D floor plans relative to one another. Fine positioning of the 3D floor plans relative to one another may be handled automatically based on the rough relative positioning. This may reduce the amount of user input/time required and/or provide a better user experience. Automatic movements of the 3D floor plans 300, 600 may include animations, sounds (e.g., a snapping sound as the 3D floor plans are “snapped” into adjacent positions), and/or provide guidance and feedback to make the determination of a positional relationship based on user input an efficient and desirable user experience.

FIG. 10 is a flowchart illustrating a process 1000 for improving a combined 3D floor plan. In this example, elements of the combined 3D floor plans are aggregated and grouped as illustrated in aggregating block 1010 and grouping block 1020. Aggregating block 1010 identifies doors and door openings in block 1012, walls in block 1014, and windows in block 1016. Elements detected in multiple rooms that are spatially close together at mapping block 1022 and grouped together in grouping block 1024 are used to improve the combined 3D floor plan. For example, the mapping and grouping may identify that one wall is connecting/separating two rooms and one door is connecting those two rooms, and each of these groupings may be identified and used as a constraint in improving/optimizing the 3D floor plan at merging/improving block 1030.

Merging/Improving block 1030 performs a room update at block 1032, which may move or rotate the individual 3D floor plans relative to one another, e.g., to make walls parallel and/or perpendicular, hallways straight, etc. At block 1034 the process merges merge elements (e.g., planes representing adjacent walls). This may be based on the groupings from block 1020. Merging of wall planes may assume a wall thickness. For example, wall thickness may be based on the geographic location of the house, e.g., walls in the Florida may be expected to have a thickness of X inches, etc.

At block 1034 the process also updates corners of elements of adjacent rooms to align with one another. One or more optimization processes may be used. For example, such an optimization may use constraints from the groupings and iterative rotate and/or move each of the 3D floor plans to minimize error/distance measures. Each 3D floor plan may (or may not) be treated as a rigid body during such optimizations. Such optimizations may improve alignment and reduce erroneous gaps between adjacent 3D floor plan elements in the combined 3D floor plan.

At block 1036, wall elements (e.g., windows, doors, etc.) are reprojected onto any walls that were merged at block 1034. These elements may have (prior to the wall merging) been positioned on different planes and thus the merging may leave them “floating” in space. The wall elements (e.g., doors, windows, etc.) are reprojected onto the merged wall location can address this “floating” disconnected appearance. Reprojecting may involve calculating an orthographic projection onto the new merged wall position. At block 1040, a standardization process is executed to give the combined 3D floor plan a standardized appearance.

The process 1000 may improve a combined 3D floor plan in various ways. It may remove the appearance of double walls, align corners, and align other elements so that the combined 3D floor plan has an appearance that is accurate, easy to understand, and that is otherwise consistent with user expectations.

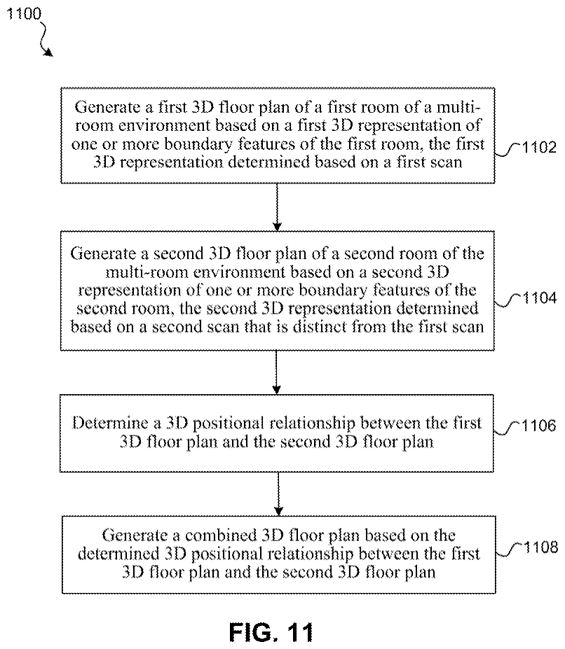

FIG. 11 is a flowchart illustrating a process 1100 for generating a combined 3D floor plan. In some implementations, a device such as electronic device 110 performs method 1100. In some implementations, method 1100 is performed on a mobile device, desktop, laptop, HMD, or server device. The method 1100 is performed by processing logic, including hardware, firmware, software, or a combination thereof. In some implementations, the method 1100 is performed on a processor executing code stored in a non-transitory computer-readable medium (e.g., a memory).

At block 1102, the method 1100 generates a first 3D floor plan of a first room of a multi-room environment based on a first 3D representation (e.g., point cloud/mesh) of one or more boundary features (e.g., walls, doors, windows, etc.) of the first room. This first 3D representation is determined based on a first scan.

At block 1104, the method 1100 generates a second 3D floor plan of a second room of the multi-room environment based on a second 3D representation (e.g., point cloud/mesh) of one or more boundary features (e.g., walls, doors, windows, etc.) of the second room. The second 3D representation is determined based on a second scan that is distinct from the first scan. The position of the one or more scanning devices that are used for the first and second scan may not be continuous or may otherwise be unavailable for use to positionally associate the distinct scans with one another.

At block 1106, the method 1100 determines a 3D positional relationship between the first 3D floor plan and the second 3D floor plan. Such a determination may be desirable, for example, in circumstances in which scanning device position changes between scans are not available for use in positionally associating the distinct scans with one another.

Some implementations provide an automatic or semi-automatic method of determining the 3D positional relationship between the first 3D floor plan and the second 3D floor plan, e.g., as illustrated in FIGS. 8A-I. In some implementations, the 3D positional relationship between the floor plans is determined based on a re-localization of a scanning device in the first room during the second scanning process. In some implementations, such a re-localization of the scanning device in the first room comprises matching feature points from the first scan with feature points from the second scan. Guidance may be provided before, during, and after such re-localization to guide a user to start scanning/re-localizing in a previously-scanned room, guide the user move about during that re-localization, provide notification that the re-localization is complete, guide the user to conclude scanning for re-localization purposes once re-localization has been successful, and/or guide the user to move to the second room following the re-localization.

In some implementations, determining the 3D positional relationship between the first 3D floor plan and the second 3D floor plan comprises, during the second scanning process, re-localizing a scanning device in the first room and tracking a position of the scanning device as the scanning device moves from the first room to the second room. Determining the 3D positional relationship may involve, during the second scanning process, tracking the position of the scanning device as the scanning device moves from one story to another story of multiple stories in the multi-room environment. Such tracking may involve use of motion sensors and/or visual inertial odometry (VIO) based on images captured by the scanning device during the second scan. In some implementations, the method 1100 initiates capture of sensor data for the second scan based on determining that the scanning device is within the second room based on detecting a new room automatically and/or based on user input.

Some implementations provide a process that involve manual input (e.g., movement of representations) on a user interface to determine the 3D positional relationship between the first 3D floor plan and the second 3D floor plan, e.g., as illustrated in FIGS. 9A-C. In some implementations, determining the 3D positional relationship between the 3D floor plans involves presenting a first layout representing the first scan and a second layout representing the second scan on a user interface, receiving input repositioning the first layout or the second layout, and determining the 3D positional relationship based on the repositioning. Such presenting may involve automatically orienting the first layout and the second layout based on cardinal directions associated with the first scan and second scan, e.g., aligning both 3D floor plans with respect to north. In some implementations, the method 1000 determines that the first layout and second layout satisfy a positional condition during the input repositioning the first layout or the second layout and automatically aligns a boundary of the first layout with a boundary of the second layout based on the positional condition. The aligning may involve aligning corners, walls, doors, or other elements.

In some implementations, determining the 3D positional relationship between the 3D floor plans involves determining preliminary 3D positional relationship and adjusting the preliminary 3D positional relationship based on an optimization using one or more constraints. For example, the one or more constraints may comprise one or more constraints corresponding to a difference between representations of a door between adjacent rooms, a difference between representations of a window between adjacent rooms, or a difference between representations of a wall between adjacent rooms.

At block 1108, the method generates a combined 3D floor plan based on the determined 3D positional relationship between the first 3D floor plan and the second 3D floor plan. Generating the combined 3D floor plan can improve the combined 3D floor plan as described with respect to FIG. 10. For example, generating the combined 3D floor plan may involve merging representations of a wall between adjacent rooms and reprojecting a door or window based on the merging.

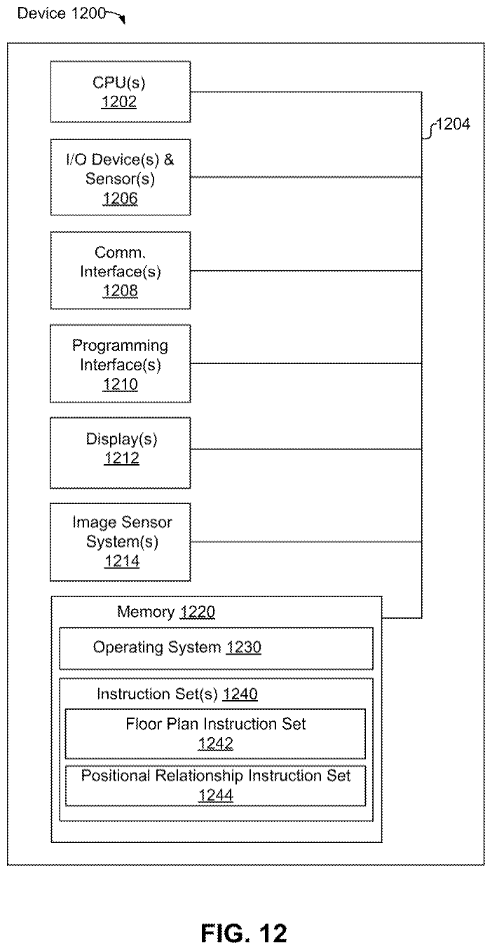

FIG. 12 is a block diagram of electronic device 1200. Device 1200 illustrates an exemplary device configuration for electronic device 110. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1200 includes one or more processing units 1202 (e.g., microprocessors, ASICs, FPGAs, GPUs, CPUs, processing cores, and/or the like), one or more input/output (I/O) devices and sensors 1206, one or more communication interfaces 1208 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 1210, one or more output device(s) 1212, one or more interior and/or exterior facing image sensor systems 1214, a memory 1220, and one or more communication buses 1204 for interconnecting these and various other components.

In some implementations, the one or more communication buses 1204 include circuitry that interconnects and controls communications between system components. In some implementations, the one or more I/O devices and sensors 1206 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 1212 include one or more displays configured to present a view of a 3D environment to the user. In some implementations, the one or more displays 1212 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 1200 includes a single display. In another example, the device 1200 includes a display for each eye of the user.

In some implementations, the one or more output device(s) 1212 include one or more audio producing devices. In some implementations, the one or more output device(s) 1212 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. The one or more output device(s) 1212 may additionally or alternatively be configured to generate haptics.

In some implementations, the one or more image sensor systems 1214 are configured to obtain image data that corresponds to at least a portion of a physical environment. For example, the one or more image sensor systems 1214 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1214 further include illumination sources that emit light, such as a flash. In various implementations, the one or more image sensor systems 1214 further include an on-camera image signal processor (ISP) configured to execute a plurality of processing operations on the image data.

The memory 1220 includes high-speed random-access memory, such as DRAM, SRAM, DDR RAM, or other random-access solid-state memory devices. In some implementations, the memory 1220 includes non-volatile memory, such as one or more magnetic disk storage devices, optical disk storage devices, flash memory devices, or other non-volatile solid-state storage devices. The memory 1220 optionally includes one or more storage devices remotely located from the one or more processing units 1202. The memory 1220 comprises a non-transitory computer readable storage medium.

In some implementations, the memory 1220 or the non-transitory computer readable storage medium of the memory 1220 stores an optional operating system 1230 and one or more instruction set(s) 1240. The operating system 1230 includes procedures for handling various basic system services and for performing hardware dependent tasks. In some implementations, the instruction set(s) 1240 include executable software defined by binary information stored in the form of electrical charge. In some implementations, the instruction set(s) 1240 are software that is executable by the one or more processing units 1202 to carry out one or more of the techniques described herein.

The instruction set(s) 1240 include a floor plan instruction set 1242 configured to, upon execution, obtain sensor data, provide views/representations, select sets of sensor data, and/or generate 3D point clouds, 3D meshes, 3D floor plans, and/or other 3D representations of physical environments as described herein. The instruction set(s) 1240 further include a positional relationship instruction set 1244 configured to determine positional relationships between multiple 3D floor plans as described herein. The instruction set(s) 1240 may be embodied as a single software executable or multiple software executables.

Although the instruction set(s) 1240 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a device having a processor:
generating a first three-dimensional (3D) floor plan of a first room of a multi-room environment based on a first 3D representation of one or more boundary features of the first room, the first 3D representation determined based on a first scan;
generating a second 3D floor plan of a second room of the multi-room environment based on a second 3D representation of one or more boundary features of the second room, the second 3D representation determined based on a second scan that is distinct from the first scan;
determining a 3D positional relationship between the first 3D floor plan and the second 3D floor plan; and
generating a combined 3D floor plan based on the determined 3D positional relationship between the first 3D floor plan and the second 3D floor plan.

2. The method of claim 1, wherein the 3D positional relationship between the first 3D floor plan and the second 3D floor plan is determined based on a re-localization of a scanning device in the first room during the second scanning process.

3. The method of claim 2, wherein the re-localization of the scanning device in the first room comprises matching feature points from the first scan with feature points from the second scan.

4. The method of claim 2 further comprising providing an indication indicating that the re-localization is complete.

5. The method of claim 1, wherein determining the 3D positional relationship between the first 3D floor plan and the second 3D floor plan comprises, during the second scanning process:
re-localizing a scanning device in the first room; and
tracking a position of the scanning device as the scanning device moves from the first room to the second room.

6. The method of claim 5, wherein determining the 3D positional relationship between the first 3D floor plan and the second 3D floor plan comprises, during the second scanning process, tracking the position of the scanning device as the scanning device moves from one story to another story of multiple stories in the multi-room environment.

7. The method of claim 5, wherein tracking the position of the scanning device comprises visual inertial odometry (VIO) based on images captured by the scanning device during the second scan.

8. The method of claim 5 further comprising initiating capture of sensor data for the second scan based on determining that the scanning device is within the second room.

9. The method of claim 1, wherein determining the 3D positional relationship between the first 3D floor plan and the second 3D floor plan comprises:
presenting a first layout representing the first scan and a second layout representing the second scan on a user interface;
receiving input repositioning the first layout or the second layout; and
determining the 3D positional relationship based on the repositioning.

10. The method of claim 9, wherein the presenting comprising orienting the first layout and the second layout based on cardinal directions associated with the first scan and second scan.

11. The method of claim 9 further comprising:
determining that the first layout and second layout satisfy a positional condition during the input repositioning the first layout or the second layout; and
automatically aligning a boundary of the first layout with a boundary of the second layout based on the positional condition.

12. The method of claim 11, wherein the aligning comprises aligning corners, walls, or doors.

13. The method of claim 1, wherein determining the 3D positional relationship between the first 3D floor plan and the second 3D floor plan comprises:
determining preliminary 3D positional relationship; and
adjusting the preliminary 3D positional relationship based on an optimization using one or more constraints.

14. The method of claim 13, wherein the one or more constraints comprise a constraint corresponding to:
a difference between representations of a door between adjacent rooms;
a difference between representations of a window between adjacent rooms; or
a difference between representations of a wall between adjacent rooms.

15. The method of claim 1, wherein generating the combined 3D floor plan comprises merging representations of a wall between adjacent rooms and reprojecting a door or window based on the merging.

16. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
generating a first three-dimensional (3D) floor plan of a first room of a multi-room environment based on a first 3D representation of one or more boundary features of the first room, the first 3D representation determined based on a first scan;
generating a second 3D floor plan of a second room of the multi-room environment based on a second 3D representation of one or more boundary features of the second room, the second 3D representation determined based on a second scan that is distinct from the first scan;
determining a 3D positional relationship between the first 3D floor plan and the second 3D floor plan; and
generating a combined 3D floor plan based on the determined 3D positional relationship between the first 3D floor plan and the second 3D floor plan.

17. The system of claim 16, wherein the 3D positional relationship between the first 3D floor plan and the second 3D floor plan is determined based on a re-localization of a scanning device in the first room during the second scanning process.

18. The system of claim 17, wherein the re-localization of the scanning device in the first room comprises matching feature points from the first scan with feature points from the second scan.

19. The system of claim 17, wherein the operations further comprise providing an indication indicating that the re-localization is complete.

20. A non-transitory computer-readable storage medium storing program instructions executable via one or more processors to perform operations comprising:
generating a first three-dimensional (3D) floor plan of a first room of a multi-room environment based on a first 3D representation of one or more boundary features of the first room, the first 3D representation determined based on a first scan;
generating a second 3D floor plan of a second room of the multi-room environment based on a second 3D representation of one or more boundary features of the second room, the second 3D representation determined based on a second scan that is distinct from the first scan;
determining a 3D positional relationship between the first 3D floor plan and the second 3D floor plan; and
generating a combined 3D floor plan based on the determined 3D positional relationship between the first 3D floor plan and the second 3D floor plan.
